(19) United States
(12) Patent Application Publication
(10) Pub. No.: US 2012/0060864 A1
(43) Pub. Date: Mar. 15, 2012

(54) E-Z BRUSH SYSTEMS

(76) Inventor: Tom Nowakowski, Joliet, IL (US)

(21) Appl. No.: 13/229,748

(22) Filed: Sep. 11, 2011

Related U.S. Application Data
(60) Provisional application No. 61/383,198, filed on Sep. 15, 2010.

(51) Int. Cl. A47L 17/00; B08B 1/00; A46B 5/02

(52) U.S. Cl. 134/6; 15/176.1; 15/111; 15/104.94; 15/143.1

(57) ABSTRACT

A barbeque brush device comprising: a brush assembly. The brush assembly includes: at least one removably attachable brush head having a receiver aperture, a handle with an extruded post, an end-scraper, and a wire loop. The brush assembly of the barbeque brush system is usable to remove debris and thereby clean at least one surface of a barbeque grill. The extruded post of the handle comprises a universal ball and socket system. The removably attachable brush head(s) is swivelly-held located at a heat-isolated distance from the handle via the universal ball and socket system. The receiver aperture of the removably attachable brush head(s) couplably receives the extruded post on the handle. The removably attachable brush head(s) is used as a cleaning means for use on the surface(s) of a barbeque grill.

### CROSS-REFERENCE TO RELATED APPLICATION

The present application is related to and claims priority from prior provisional application Ser. No. 61/383,198, filed Sep. 15, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of brushes and more specifically relates to barbeque brushes.

2. Description of the Related Art

Many individuals in modem society use barbecue grills for cooking comestibles. Heat is applied to the food typically by fuel-fed flames directed from beneath. There are several varieties of such grills, with most falling into one of two categories: gas-fueled and charcoal.

Grills may come in large, custom designed brick or steel grills or smaller versions for household use. All of these grills need cleaning from time to time in between uses to maintain the equipment to prolong longevity and to provide a healthy surface on which to cook. The heat and smoke created from the grease dripping off of the cooking food combined with burning charcoal or wood causes the metallic surface of the grill to eventually become charred and coated with a thick layer of grime which may be difficult to remove. If the grill is to be maintained in a pristine condition, the tedious task of removing the grill after every use and washing it may be necessary with certain versions.

Brushes may be used to clean grills; however brushes may prove difficult to manipulate and may cause damage to the surface(s). Particularly, most of the cleaning brushes contain short bristles which can, over a short period of time, wear away, rendering the cleaning tool useless after only a few applications. Additionally, the handles of these tools are also shortened, which can pose the risk of burns if one is attempting to clean the grill while it is still hot. In addition, it is often necessary to employ different brush strengths to help remove the toughest of residue. While effective, relying on a collection of cleaning equipment just to perform grill maintenance can be a costly endeavor.

Various attempts have been made to solve problems found in the brush and multi-tool art. Among these are found in: U.S. Pat. No. 3,434,175 to Sidney Crockett Bray et al; U.S. Design Pat. No. D601,346 to Michael Wales; U.S. Pat. No. 5,479,673 to Bruce M. Carton; U.S. Pat. No. 6,155,620 to Armstrong; and U.S. Pat. No. 7,032,941 to Heneveld; and U.S. Pat. No. 5,810,408 to Armstrong. This prior art is representative of brushes and tools with various head(s).

None of the above inventions and patents, taken either singly or in combination, is *seen to describe the invention as claimed. Thus, a need exists for a reliable barbeque grill cleaning brush to avoid the above-mentioned problems.

### BRIEF SUMMARY OF THE INVENTION

In view of the foregoing disadvantages inherent in the known barbeque brush art, the present invention provides novel E-Z brush systems. The general purpose of the present invention, which will be described subsequently in greater detail is to provide an efficient, easy-to-use cleaning utensil for barbecue grills. Offering a versatile handle with a series of heavy duty brush head(s), as well as a scraper, into one easy to use unit, this product virtually eliminates the need to spend extra money and change-out time using a collection of cleaning tools. The ball and socket design ensures the brush head(s) installation in mere seconds, without having to rely on additional hand tools to complete the process.

The present barbeque brush device as disclosed herein preferably comprises: a brush assembly. The brush assembly preferably includes: at least one removably attachable brush head having a receiver aperture, a handle with an extruded post, an end-scraper, and a wire loop. The brush assembly of the barbeque brush system is usable to remove debris and thereby clean at least one surface of a barbeque grill. The extruded post of the handle comprises a universal ball and socket system useful for articulating brush heads thereon as the brush heads are moved across the surface of the grill while cleaning. The receiver aperture of the removably attachable brush head(s) couplably receives the extruded post on the handle. The removably attachable brush head(s) is able to swivel in relation to the handle.

The removably attachable brush head(s) comprise in one head a long bristled wire brush, in another a steel wool brush, and yet another a scouring brush infused with at least one cleaning material for use on the surface of a barbeque grill when cool. The cleaning material preferably comprises at least one impregnated soap. The removably attachable brush head(s) may be used independently of the brush to clean the barbeque grill. The removably attachable brush head(s) is swivelly-held located at a heat-isolated distance from the handle via the universal ball and socket system. In this way the user effectively is prevented from being burned while cleaning.

The removably attachable brush head(s) are interchangeable and snap in and out (or other equivalent fastening means may be used) of a coupled relationship with the handle. The removably attachable brush head(s) comprises a top. The top of the removably attachable brush head(s) comprise plastic and the bottom portion (bristles or other are attached to the top.) The top of the removably attachable brush head(s) comprise dimensions of about 3½′ inches in length by about 2½″ inches in width providing a suitably large bristle or other mounting surface.

The handle comprises a grip preferably comprising heat-resistant silicone and measures about 7″ inches in length and about 1½″ inches in width. The handle may further comprise a wire loop whereby the brush assembly may be hanged from the barbeque grill. The end-scraper comprises stainless steel so as to not compromise the grill surface when scraped. The end-scraper preferably measures about 1 inch in length and has a width (at a widest point of the end-scraper) which tapers out to about 2¼″ inches.

A kit is embodied herein for the E-Z brush systems comprising: a barbeque brush device; a plurality of removably attachable brush head(s) preferably including a long bristled wire brush, a steel wool brush, and a scouring brush; and at least one set of user's instructions.

In accordance with the embodiments of the present invention a preferred method of use is disclosed herein comprising: attaching removably attachable brush head(s) to a handle in succession; performing a first-cleaning operation of a surface of a barbeque grill using a long bristled wire brush version of the removably attachable brush; removing the removably attachable brush head(s); performing a second-cleaning operation of the surface of the barbeque grill using a steel wool brush of the removably attachable brush; removing the removably attachable brush head(s); and performing a third-cleaning operation of the surface of the barbeque grill using a scouring brush infused with at least one cleaning material for use on the at least one surface of a barbeque grill (when cool.) The first-cleaning operation; the second-cleaning operation; and the third-cleaning operation are done before a cooking session or after the cooking session on the barbeque grill.

The present invention holds significant improvements and serves as E-Z brush systems. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, E-Z Brush systems constructed and operative according to the teachings of the present invention.

FIG. 1 shows a perspective view illustrating an E-Z brush system in an ‘in-use’ position according to an embodiment of the present invention

FIG. 2 is a perspective view illustrating a barbeque brush device with removably attachable brush head(s) of the E-Z brush system according to an embodiment of the present invention.

FIG. 3 is a perspective view illustrating the removably attachable brush head(s) of E-Z brush system according to an embodiment of the present invention.

FIG. 4 is a flowchart illustrating a method of use according to an embodiment of the present invention of FIGS. 1-3.

The various embodiments of the present invention will hereinafter be described in conjunction with the appended drawings, wherein like designations denote like elements.

### DETAILED DESCRIPTION

As discussed above, embodiments of the present invention relate to a barbeque brush device and more particularly to E-Z brush systems as used for a cleaning utensil on barbecue grills

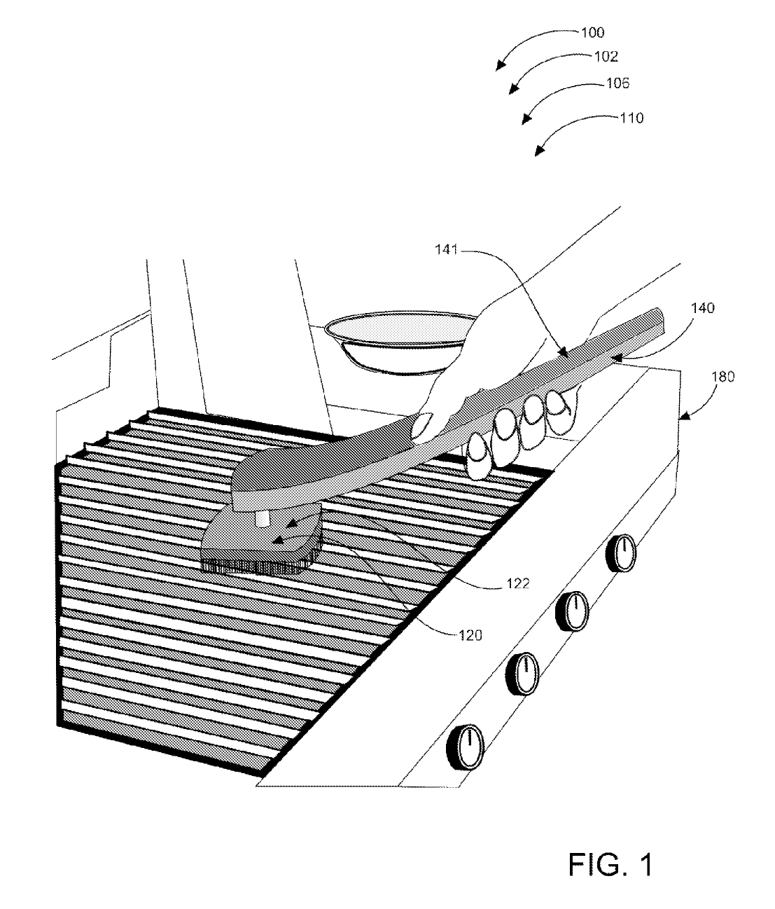

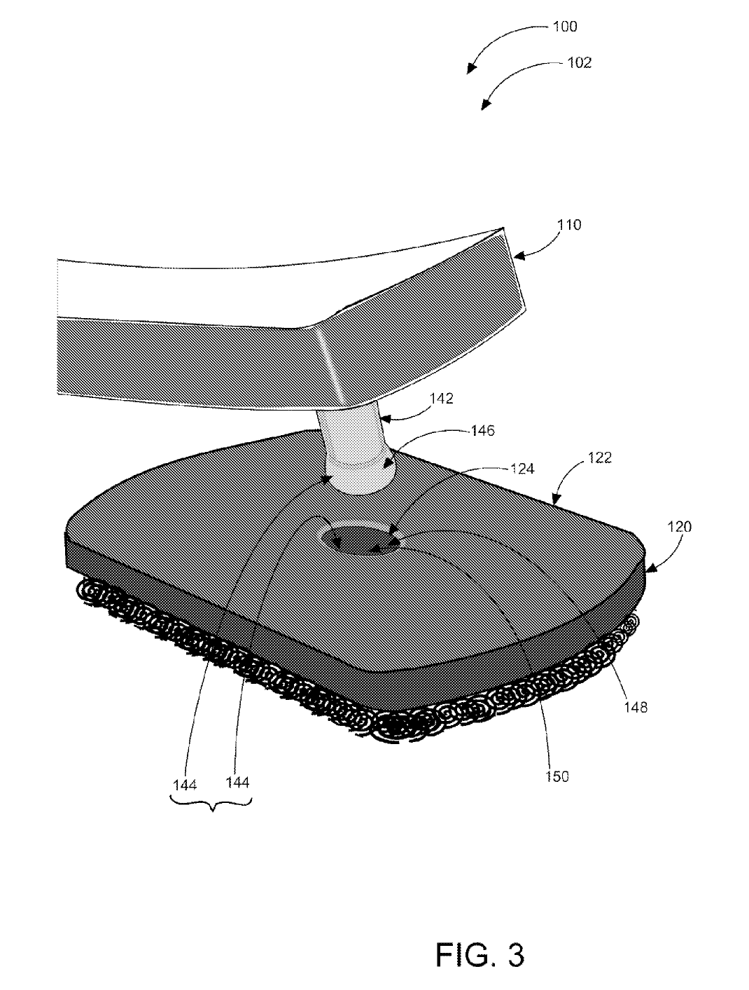

Referring now to the drawings FIGS. 1-3, showing perspective views of E-Z brush systems 100 according to embodiments of the present invention. E-Z brush systems 100 preferably comprises barbeque brush device 102. Barbeque brush device 102 includes brush assembly 110. Brush assembly 110 of E-Z brush systems 100 is preferably usable to remove debris and thereby is usable to clean at least one surface of barbeque grill 180 as shown best in FIG. 1. Brush assembly 110 includes: at least one removably attachable brush head(s) 120 having receiver aperture 124, handle 140 with extruded post 142, end-scraper 160, and wire loop 170.

Receiver aperture 124 of removably attachable brush head(s) 120 preferably couplably receives extruded post 142 on handle 140. Extruded post 142 of handle 140 comprises universal ball and socket system 144. Removably attachable brush head(s) 120 is preferably swivelly-held and located at a heat-isolated distance from handle 140 via universal ball and socket system 144. Further, removably attachable brush head(s) 120 is preferably able to swivel (articulate) in relation to handle 140.

Universal ball and socket system 144 preferably allows removably attachable brush head(s) 120 to pivot in a 360-degree rotation thereby facilitating maximum surface coverage as several angles (and/or contours) of brushing may be accomplished at once. Further, universal ball and socket system 144 comprises ball 146 and socket 148. Barbeque brush device 102 preferably is manipulatably-swivelable about node 150 within universal ball and socket system 144. Node 150 may define a pivot point. The pivot point is preferably located underneath ball 146 in universal ball and socket system 144. Further, handle 140 of barbeque brush device 102 terminates at node 150, such that universal ball and socket system 144 when manipulated is able to determine a relative orientation of removably attachable brush head(s) 120 in relation to handle 140.

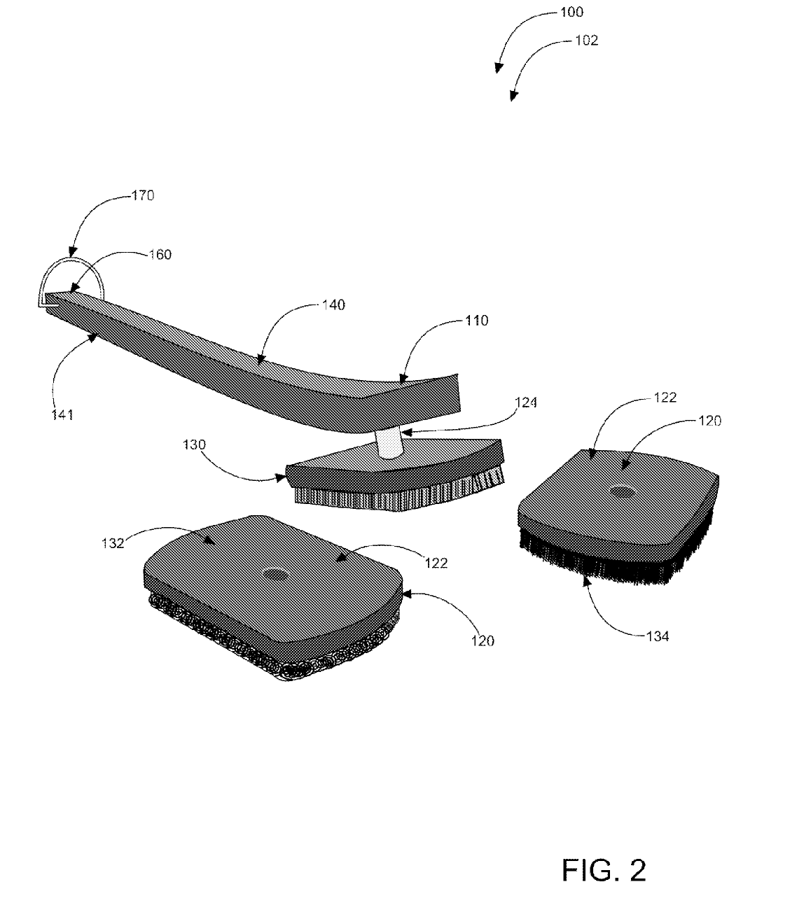

Removably attachable brush head(s) 120 is preferably interchangeable and snaps in and out of a coupled relationship with handle 140. Removably attachable brush head(s) 120 comprises long bristled wire brush head 130, steel wool brush head 132, and scouring brush head 134 the versions as shown best in FIG. 2. The scouring brush may be infused with at least one cleaning material for use on the at least one surface of barbeque grill 180 when cool as shown in ‘in-use’ condition 106 of FIG. 1. The cleaning material comprises at least one impregnated soap.

Removably attachable brush head(s) 120 may be used independently of barbeque brush device 102 to clean barbeque grill 180 if desired. Removably attachable brush head(s) 120 comprises top 122. Top 122 of removably attachable brush head(s) 120 comprise plastic. Top 122 of removably attachable brush head(s) 120 comprise dimensions of about 3½″ inches in length by about 2½″ inches in width in preferred embodiments.

Handle 140 comprises grip 141 comprising heat-resistant silicone and measures about 7″ inches in length and about 1½″ inches in width such that the user's hands are a suitable distance from the heat of the grill. Handle 140 further comprises wire loop 170 whereby brush assembly 110 may be hanged from barbeque grill 180. End-scraper 160 comprises stainless steel. End-scraper 160 measures about 1 inch in length and has a width at a widest point of the end-scraper which tapers out to about 2¼″ inches. End-scraper 160 features a sharpened edge for reaching regions on a surface of barbeque grill 180 that were not previously reached using removably attachable brush head(s) 120.

E-Z brush systems 100 may be sold as kit 440 comprising barbeque brush device 102; removably attachable brush head(s) 120 preferably including long bristled wire brush 130, steel wool brush 132, and scouring brush 134; and at least one set of user's instructions. Other removably attachable brush head(s) 120 may be included within kit 340. E-Z brush systems 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different bristle combinations, parts may be sold separately, etc., may be sufficient.

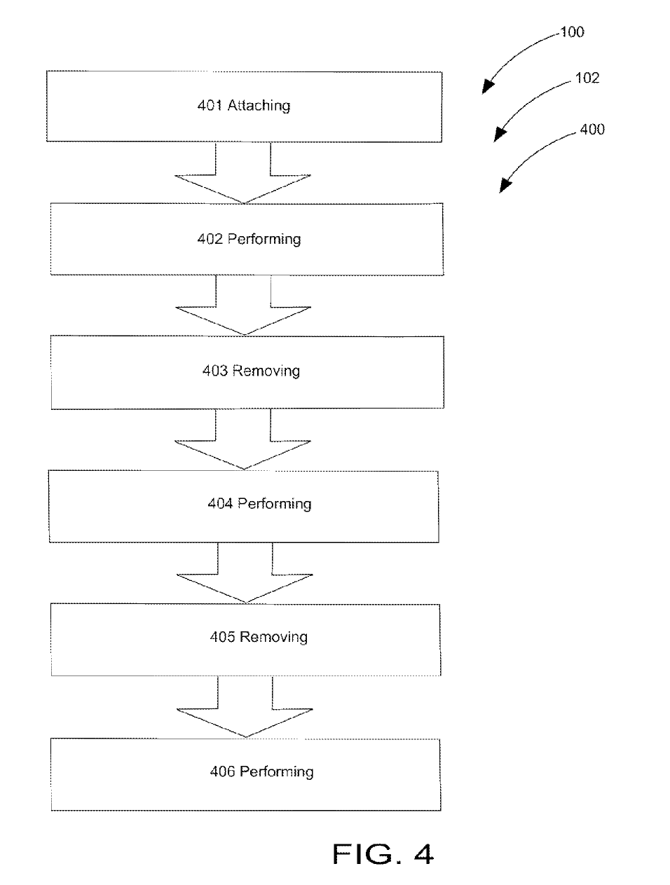

FIG. 4. shows a flowchart 450 illustrating a method of use 400 according to an embodiment of the present invention of FIGS. 1-3.

Referring now to FIG. 4. showing a method (at least herein embodying method of use 400) of using E-Z brush systems 100 preferably comprises the steps of: step one 401 attaching removably attachable brush head(s) 120 to handle 140 in succession; step two 402 performing a first-cleaning operation of a surface of barbeque grill 170 using a long bristled wire brush head 130 version of removable barbeque brush device 102; step three 403 removing removably attachable brush head(s) 120; step four 404 performing a second-cleaning operation of the surface of the barbeque grill 170 using steel wool brush 134 of barbeque brush device 102; step five 405 removing removably attachable brush head(s) 120; and step six 406 performing a third-cleaning operation of the surface of the barbeque grill 170 using scouring brush 134 infused with at least one cleaning material for use on the at least one surface of a barbeque grill 170 when cool. The first-cleaning operation; the second-cleaning operation; and the third-cleaning operation are done before a cooking session or after the cooking session on barbeque grill 170. Certain cleaning steps may be optional depending on the condition of the grill.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A barbeque brush system comprising:
a brush assembly including,
at least one removably attachable brush head(s) having a receiver aperture, and
a handle with an extruded post;
wherein said receiver aperture of said removably attachable brush head(s) couplably receives said extruded post on said handle;
wherein said removably attachable brush head(s) is able to swivel articulate in relation to said handle; and
wherein said brush assembly of said barbeque brush system is usable to remove debris and thereby clean at least one surface of a barbeque grill.

2. The barbeque brush system of claim 1 further comprising at least one end-scraper.

3. The barbeque brush system of claim 1 wherein said extruded post comprises a universal ball and socket system.

4. The barbeque brush system of claim 1 wherein said removably attachable brush head(s) comprises a long bristled wire brush.

5. The barbeque brush system of claim 1 wherein said removably attachable brush head(s) comprises a steel wool brush.

6. The barbeque brush system of claim 1 wherein said removably attachable brush head(s) comprises a scouring brush infused with at least one cleaning material for use on said at least one surface of a barbeque grill when cool.

7. The barbeque brush system of claim 1 wherein said removably attachable brush head(s) are interchangeable and snap in and out of a coupled relationship with said handle.

8. The barbeque brush system of claim 3 wherein said removably attachable brush head(s) is swivelly-held located at a heat-isolated distance from said handle via said universal ball and socket system.

9. The barbeque brush system of claim 1 wherein said handle comprises a grip comprising heat-resistant silicone and measures about 7″ inches in length and about 1½″ inches in width.

10. The barbeque brush system of claim 1 wherein said handle further comprises a wire loop whereby said brush assembly may be hanged from said barbeque grill.

11. The barbeque brush system of claim 1 wherein said removably attachable brush head(s) may be used independently of said brush to clean said barbeque grill.

12. The barbeque brush system of claim 6 wherein said cleaning material comprises at least one impregnated soap.

13. The barbeque brush system of claim 1 wherein said removably attachable brush head(s) comprises a top.

14. The barbeque brush system of claim 13 wherein said top of said removably attachable brush head(s) comprise plastic.

15. The barbeque brush system of claim 13 wherein said top of said removably attachable brush head(s) comprise dimensions of about 3½″ inches in length by about 2½″ inches in width.

16. The barbeque brush system of claim 2 wherein said end-scraper comprises stainless steel.

17. The barbeque brush system of claim 16 wherein said end-scraper measures about 1 inch in length and has a width at a widest point of said end-scraper which tapers out to about 2¼″ inches.

18. A barbeque brush system comprising:
a brush assembly including,
at least one removably attachable brush head(s) having a receiver aperture,
a handle with an extruded post,
an end-scraper, and
a wire loop;
wherein said receiver aperture of said removably attachable brush head(s) couplably receives said extruded post on said handle;
wherein said removably attachable brush head(s) is able to swivel in relation to said handle;
wherein said extruded post comprises a universal ball and socket system;
wherein said removably attachable brush head(s) comprises a long bristled wire brush, and/or a steel wool brush, and/or a scouring brush infused with at least one cleaning material for use on said at least one surface of a barbeque grill when cool;
wherein said cleaning material comprises at least one impregnated soap;
wherein said removably attachable brush head(s) are interchangeable and snap in and out of a coupled relationship with said handle;
wherein said removably attachable brush head(s) may be used independently of said brush to clean said barbeque grill;
wherein said removably attachable brush head(s) is swivelly-held located at a heat-isolated distance from said handle via said universal ball and socket system;
wherein said handle comprises a grip comprising heat-resistant silicone and measures about 7″ inches in length and about 1½″ inches in width;
wherein said wire loop permits said brush assembly to be hanged from said barbeque grill;
wherein said removably attachable brush head(s) comprises a plastic top;
wherein said top of said removably attachable brush head(s) comprise dimensions of about 3½″ inches in length by about 2½″ inches in width;
wherein said end-scraper comprises stainless steel;
wherein said end-scraper measures about 1 inch in length and has a width at a widest point of said end-scraper which tapers out to about 2¼″ inches; and
wherein said brush assembly of said barbeque brush system is usable to remove debris and thereby clean at least one surface of a barbeque grill.

19. A method of using a barbeque brush system comprising the steps of:
attaching removably attachable brush head(s) to a handle in succession;
performing a first-cleaning operation of a surface of a barbeque grill using a long bristled wire brush version of said removably attachable brush;
removing said removably attachable brush head(s);
performing a second-cleaning operation of said surface of said barbeque grill using a steel wool brush of said removably attachable brush;
removing said removably attachable brush head(s); and
performing a third-cleaning operation of said surface of said barbeque grill using a scouring brush infused with at least one cleaning material for use on said at least one surface of a barbeque grill when cool.

20. The method of claim 19 wherein said first-cleaning operation; said second-cleaning operation; and said third-cleaning operation are done before a cooking session or after said cooking session on said barbeque grill.
